(19) United States
(12) Patent Application Publication
(10) Pub. No.: US 2022/0415129 A1
(43) Pub. Date: Dec. 29, 2022

(54) SYSTEM AND METHOD OF PROVIDING A HOLD AND SPIN GAME WITH BASE GAME SYMBOL PERSISTENCE

(71) Applicant: Aristocrat Technologies, Inc. (ATI), Las Vegas, NV (US)

(72) Inventors: Eric Boese, Decatur, GA (US); Bradley Schultz, Brookhaven, GA (US); Ronald J. Williams, II, Atlanta, GA (US)

(21) Appl. No.: 17/844,180

(22) Filed: Jun. 20, 2022

Related U.S. Application Data
(60) Provisional application No. 63/330,550, filed on Apr. 13, 2022.
(60) Provisional application No. 63/216,342, filed on Jun. 29, 2021.

(51) Int. Cl. G07F 17/32

(52) U.S. Cl. CPC G07F 17/3265; G07F 17/3267; G07F 17/34

(57) ABSTRACT

A gaming machine includes a player interface, a display system, and a control system. For a play of a base game, the control system holds configurable symbols in a persistent symbol display matrix, presents symbols in a base game display matrix, updates display positions of the persistent symbol display matrix that are without configurable symbols, and triggers a feature game based on configurable symbols in the base game display matrix. For each spin of a feature game, the control system holds configurable symbols in the base game display matrix and in the persistent symbol display matrix, selects replacement symbols for each display position in the base game display matrix and the persistent symbol display matrix that is without a held symbol, and presents a feature game award based on configurable symbols in the base game display matrix and the persistent symbol display matrix.

### RELATED APPLICATIONS

This application claims priority to U.S. Provisional Patent Application No. 63/330,550, filed on Apr. 13, 2022 and claims priority to U.S. Provisional Patent Application No. 63/216,342, filed on Jun. 29, 2021, the disclosures of which are hereby incorporated herein by reference in their entirety.

### BACKGROUND

Electronic gaming machines or gaming devices provide a variety of wagering games such as slot games, video poker games, video blackjack games, roulette games, video bingo games, keno games that are frequently offered at casinos and other locations. Play on gaming machines typically involves a player establishing a credit balance by inputting money, or another form of monetary credit, and placing a monetary wager (from the credit balance) on one or more outcomes of an instance (or single play) of a primary or base game. In many games, a player may qualify for secondary games or bonus rounds by attaining a certain winning combination or triggering event in the base game. Secondary games provide an opportunity to win additional game instances, credits, awards, jackpots, progressives, etc. Awards from any winning outcomes are typically added back to the credit balance and may be provided to the player upon completion of a gaming session or when the player wants to “cash out.”

“Slot” type games are often displayed to the player in the form of various symbols arrayed in a row-by-column grid or matrix. Specific symbol combinations along predetermined paths (or paylines) through the matrix indicate the outcome of the game. The display typically highlights winning combinations/outcomes for ready identification by the player. Specific symbol combinations and their corresponding awards are usually shown in a “pay-table” which is available to the player for reference. Often, the player may vary his/her wager to include differing quantities of paylines and/or the amount bet on each line. By varying the wager, the player may sometimes alter the frequency or quantity of winning symbol combinations, frequency or quantity of secondary games, and/or the amount awarded.

Typical wagering games use a random number generator (RNG) to randomly determine the outcome of each game. The wagering game is designed to return a certain percentage of the amount wagered back to the player (i.e., return-to-player) over the course of many plays or instances of the game. The return-to-player and randomness of the RNG are critical to ensuring the fairness of the games and are, therefore, highly regulated. Upon initiation of play, the RNG randomly determines a game outcome and symbols are then selected which correspond to that outcome. Notably, some games may include an element of skill on the part of the player and are, therefore, not entirely random.

In existing gaming systems, feature games, secondary games, or bonus games may be triggered during a base game. A feature game gives players an additional opportunity to win prizes, or the opportunity to win larger prizes, than would otherwise be available in the base game. Feature games may also offer altered game play to enhance player enjoyment.

The popularity of such gaming machines is heavily dependent on the perceived entertainment value of the provided gaming experience. Operators of gaming businesses therefore demand the most entertaining, engaging, and exciting gaming machines so as to attract and retain patrons. To satisfy such demand, game developers are continuously inventing new gaming features. However, it is not enough for a new gaming feature to be entertaining, engaging, and exciting, the new gaming feature must also be realizable in a manner that satisfies regulatory requirements. As such, gaming developers must not only satisfy the entertainment side of creating a new gaming feature, but must also address the technical side. In particular, gaming developers must identify technical problems associated with implementing the new feature and create technical solutions in order to bring their creation to market. Thus, there is a not only continuing need for new gaming features that are entertaining but also a continuing need for the technical solutions needed to bring such gaming features to market.

### SUMMARY

According to various embodiments, a gaming machine includes a player interface, a display system, and a control system. For a play of a base game, the control system holds configurable symbols in a persistent symbol display matrix, presents symbols in a base game display matrix, updates display positions of the persistent symbol display matrix that are without configurable symbols, and triggers a feature game based on configurable symbols in the base game display matrix. For each spin of a feature game, the control system holds configurable symbols in the base game display matrix and in the persistent symbol display matrix, selects replacement symbols for each display position in the base game display matrix and the persistent symbol display matrix that is without a held symbol, and presents a feature game award based on configurable symbols in the base game display matrix and the persistent symbol display matrix.

According to aspects of various embodiments, the control system may activate a zone of the persistent symbol display matrix in response to the replacement symbols presenting a zone activation symbol in the base game display matrix, and may determine the sum of values for the feature game award based on symbols in active zones of the persistent symbol display matrix, but not on configurable symbols in inactive zones of the persistent symbol display matrix. The control system may also hold, for each spin of the feature game, the zone activation symbol at its respective display positions in the base game display matrix.

According to additional aspects, the control system may clear configurable symbols from the persistent symbol display matrix after presenting the feature game award. The control system may also seed the persistent symbol display matrix with configurable symbols prior to a subsequent play of the base game.

Pursuant to yet additional aspects, the control system may activate a first zone of the persistent symbol display matrix in response to the replacement symbols presenting a first zone activation symbol in the base game display matrix, and may activate a second zone of the persistent symbol display matrix in response to the replacement symbols presenting a second zone activation symbol in the base game display matrix. The control system may also determine the sum of values for the feature game award based on configurable symbols in active zones of the persistent symbol display matrix, but not on configurable symbols in inactive zones of the persistent symbol display matrix. Moreover, the control system, for each spin of the feature game, may hold the first zone activation symbol at its respective display positions in the base game display matrix, and may hold the second zone activation symbol at its respective display positions in the base game display matrix.

Accordingly to further aspects, the control system may activate a first zone of the persistent symbol display matrix in response to the replacement symbols presenting a first zone activation symbol in the base game display matrix, and may activate a second zone of the persistent symbol display matrix in response to the replacement symbols presenting the first zone activation symbol and a second zone activation symbol in the base game display matrix. The control system may determine the sum of values for the feature game award based on configurable symbols in active zones of the persistent symbol display matrix, but not on configurable symbols in inactive zones of the persistent symbol display matrix.

Pursuant to other aspects, the control system may increase the feature game award based on a prize value associated with a row of symbol display positions in an activated zone of the persistent symbol display matrix that is filled with configurable symbols. The control system may also select replacement symbols for a symbol display zone of the base game display matrix from a first symbol set that includes configurable symbols but no zone activation symbols, and may select replacement symbols for a first column and a last column of the base game display matrix from a second symbol set that includes zone activations symbols but no configurable symbols.

In various embodiments, a method of a gaming machine may include, for a play of a base game, holding configurable symbols at their respective display positions in a persistent symbol display matrix presented by a display system of the gaming machine, and presenting symbols in a base game display matrix presented by the display system. The method may further include updating, with a control system of the gaming machine, display positions of the persistent symbol display matrix that are without configurable symbols, and presenting a base game award in response to the symbols in the base game display matrix corresponding to a winning base game outcome. After presenting the base game award, the method may include retaining configurable symbols at their respective display positions in the persistent symbol display matrix for a subsequent play of the base game.

Per various embodiments, a non-transitory computer readable storage medium may include instructions. In response to executing the instructions, a gaming machine, for a play of a base game, may hold configurable symbols at their respective display positions in a persistent symbol display matrix presented by a display system of the gaming machine, and present symbols in a base game display matrix presented by the display system. The gaming machine may further update display positions of the persistent symbol display matrix that are without configurable symbols, and may present a base game award in response to the symbols in the base game display matrix corresponding to a winning base game outcome. The gaming machine may also selectively trigger a feature game based on configurable symbols in the based game display matrix, and for the feature game, may present a feature game award based on configurable symbols in the base game display and configurable symbols in any activated zone of the persistent symbol display matrix. If the feature game is not triggered, the gaming machine may retain configurable symbols at their respective display positions in the persistent symbol display matrix for a subsequent play of the base game.

### BRIEF DESCRIPTION OF THE DRAWINGS

Features and advantages of certain embodiments of the present disclosure will become apparent from the following description of embodiments thereof, by way of example only, with reference to the accompanying drawings, in which;

FIG. 1 is an example diagram showing several gaming machines networked with various gaming-related servers.

FIG. 2A is a block diagram showing various functional elements of an example gaming machine.

FIG. 2B depicts a casino gaming environment according to one example.

FIG. 2C is a diagram that shows examples of components of a system for providing online gaming according to some aspects of the present disclosure.

FIG. 3A is a further block diagram showing various functional elements of an embodiment of the game controller of FIG. 2A.

FIG. 3B illustrates, in block diagram form, an embodiment of a game processing architecture algorithm that implements a game processing pipeline for the play of a game in accordance with various embodiments described herein.

FIG. 4 provides a flowchart depicting operation of a gaming machine in accordance with a base game and a feature game of the present disclosure.

FIGS. 5A-5D present a series of display screens depicting operation of the gaming machine per the process of FIG. 4.

The foregoing summary, as well as the following detailed description of certain embodiments of the present disclosure, will be better understood when read in conjunction with the appended drawings. For the purpose of illustrating the disclosure, certain embodiments are shown in the drawings. It should be understood, however, that the present invention is not limited to the arrangements and instrumentality shown in the attached drawings.

### DETAILED DESCRIPTION

Embodiments provide a gaming machine, a method, and gaming system with a spinning reel game having a base game, from which a hold and spin game is triggered when a determined quantity of configurable symbols are displayed in a base game outcome. During the base game, the gaming machine may present configurable symbols in a base game outcome and may present and hold configurable symbols in one or more persistent symbol display zones. The gaming machine may retain the configurable symbols in the one or more persistent symbol display zones across plays of the base game.

When the feature game is triggered, the gaming machine may retain any configurable symbols present in a symbol display zone of the base game outcome as well as any configurable symbols present in the one or more persistent symbol display zones. During the feature game, the gaming machine may present and hold additional configurable symbols in the symbol display zone and and in the one or more persistent symbol display zones. Based on one or more symbols of a feature game outcome, a gaming machine may activate zones of the one or more persistent symbol display zones. Upon completion of the feature game, the gaming machine may award prizes associated with configurable symbols held in any symbol display zones that has been activated. After the feature game, the gaming machine may further clear the one or more persistent symbol display zones of configurable symbols and subsequently reseed the one or more persistent symbol display zones with one or more configurable symbols.

The present disclosure is generally directed to solving various technical problems associated with gaming machines that present prize values that increase as a base game is played. In some embodiments, a gaming machine may add prizes to one or more zones over a course of several plays of a base game. As the prizes accumulate in the one or more zones, a player's interest in the base game increases. In short, the greater the value of the prizes accumulated and presented to the player, the more exciting and enjoyable the playing experience is for the player. However, such presentation of high accumulated values to the player must be managed to maintain a requisite return-to-player. In particular, the game machine must manage the presentation of such prizes with the awarding of such prizes in a manner that is based on random outcomes yet is in line with the return-to-player of the machine.

As explained in greater detail below, various disclosed embodiments provide a technical solution to the above-noted balance between increasing player interest through accumulation of high valued prizes and maintaining a requisite return-to-player. In particular, various embodiments utilize a user interface that includes persistent symbol display zones that accumulate prizes. Moreover, progressive and/or fixed prizes are associated with rows of the persistent symbol display zones and awarded based on filling the respective rows with configurable symbols. While the prizes associated with the rows as well as prizes associated with each configurable symbol may be sizeable in order to garner interest, awarding of such prizes is dependent upon activation of respective persistent symbol display zones. Thus, a game designer may maintain the requisite return-to-player by controlling the frequency or odds of a particular persistent symbol display zone being activated. In short, the game designer may increase the size of prize values presented by configurable symbols and/or prize values associated with rows of the persistent symbol display zones by appropriately reducing the frequency or odds that the persistent symbol display zone is activated. In this manner, the persistent symbol display zones provide the game designer with the tools needed to address the entertainment side of game design (e.g., increased player interest) and solve the technical side of game design (e.g., maintain requisite return-to-player) so that various disclosed embodiments of a gaming machine may be brought to market.

Additionally, the user interface may provide players of the gaming machine with an easy and quick way to understand the operation of the game. For example, the player may readily recognize how close the gaming machine is to awarding a minor, mini, major, or grand prize. As explained in greater detail below, the gaming machine may populate and retain configurable symbols in persistent symbol display zones across multiple plays of a base game and may award prizes associated with rows of the persistent symbol display zones during a feature game when the respective row is filled with configurable symbols and the respective zone is activated. Thus, by merely glancing at the persistent symbol display zones during plays of the base game or even during idle periods of the gaming machine, a player may recognize that rows of the persistent symbol display zones are filled or nearly filled and thus the gaming machine is more likely to awarded associated with such rows via subsequent play of the feature game.

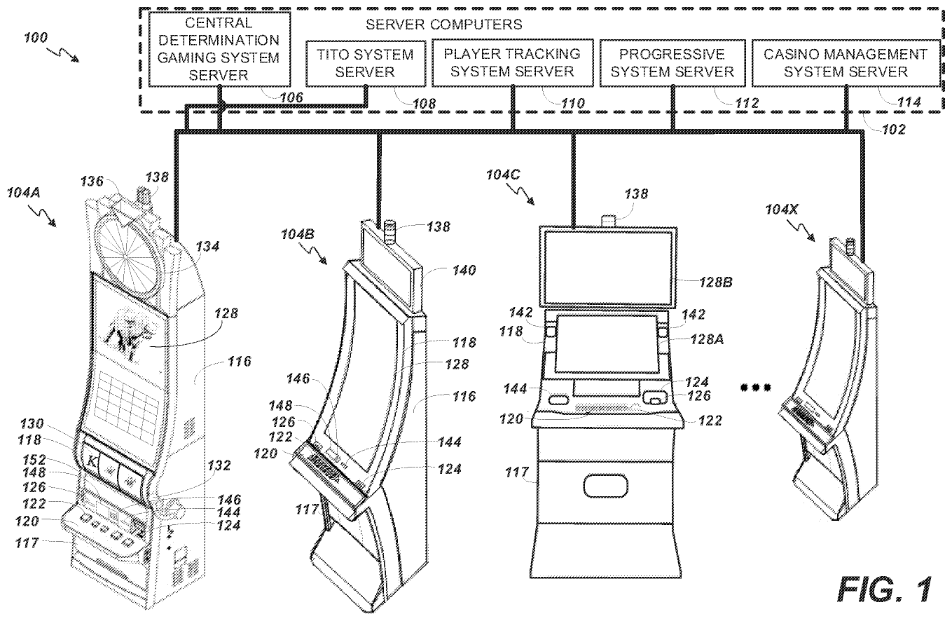

FIG. 1 illustrates several different models of gaming machines which may be networked to various gaming related servers. Shown is a system 100 in a gaming environment including one or more server computers 102 (e.g., slot servers of a casino) that are in communication, via a communications network, with one or more gaming machines 104A-104X (e.g., slot machines, video poker machines, bingo machines, etc.) that may implement one or more aspects of the present disclosure. In addition to gaming machines 104A-104X, the system 100 may include gaming devices 256 such as portable gaming devices and/or remote gaming devices. Such gaming devices 256 may include, but are not limited to, smart phones, tablets, laptops, and game consoles. To comply with regulatory requirements, gaming devices 256 may be required to include specialized software and/or hardware if used for wagering or for games of chance in which monetary awards are provided. As such, standard, commercial smart phones, tablets, laptops, and game consoles may not be suitable for all embodiments disclosed herein. However, in various embodiments, such gaming devices 256 may include specialized software and/or hardware and thus be suitable for embodiments involving wagering or monetary awards.

Communication between the gaming machines 104A-104X and the server computers 102, and among the gaming machines 104A-104X, may be direct or indirect, such as over the Internet through a website maintained by a computer on a remote server or over an online data network including commercial online service providers, Internet service providers, private networks, and the like. In other embodiments, the gaming machines 104A-104X may communicate with one another and/or the server computers 102 over RF, cable TV, satellite links and the like.

In some embodiments, server computers 102 may not be necessary and/or preferred. For example, in one or more embodiments, a stand-alone gaming machine such as gaming machine 104A, gaming machine 104B or any of the other gaming machines 104C-104X may implement one or more aspects of the present disclosure.

However, it is typical to find multiple gaming machines connected to networks implemented with one or more of the server computers 102 described herein.

Moreover, in some implementations, at least some of the gaming machines may be “thin-client” or “thick-client” gaming machines that are not configured for stand-alone determination of game outcomes, etc. Such client gaming machines may be configured for communication with one or more of the different server computers 102 described herein, including but not limited to the central determination gaming system server 106. Some such client gaming machines may, for example, be configured to accept tickets and/or cash (e.g., via a bill validator that also functions as a ticket reader) to load credits onto the client gaming machine, a ticket printer for outputting a credit ticket when a cash out button of a player interface is pressed, a player tracking card reader, etc. Some client gaming machines may include a transceiver for wireless communication with a player's mobile device, (e.g., for communication with a player's smartphone, tablet and/or mobile gaming device) a keypad 146, and/or an illuminated display 148 for reading, receiving, entering, and/or displaying player tracking information. A client gaming machine may include a display system, an audio system, etc., for presenting attract sequences, game presentations, etc. The game presentations may include game outcomes determined by another device, such as the central determination gaming system server 106.

The server computers 102 also may include a ticket-in-ticket-out (TITO) system server 108, a player tracking system server 110, a progressive system server 112, and/or a casino management system server 114. Gaming machines 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over a network to any of a group of remote terminals or remote gaming machines 104A-104X that utilize the game outcomes and display the results to the players.

Gaming machine 104A is often of a cabinet construction which may be aligned in rows or banks of similar devices for placement and operation on a casino floor. The gaming machine 104A often includes a service door or main door 117 which provides access to the interior of the cabinet. Gaming machine 104A typically includes a player interface, an access channel for a bill validator 124, and/or an access channel for a ticket printer 126. The player interface may include a button area or button deck 120 accessible by a player that includes input switches or buttons 122.

In FIG. 1, gaming machine 104A is shown as a Relm XL™ model gaming machine manufactured by Aristocrat® Technologies, Inc. In many configurations, the gaming machine 104A includes a display system comprising one or more display devices. In particular, the display system of gaming machine 104A may include a gaming display area 118 comprising a quantity (typically 3 or 5) of mechanical reels 130 with various symbols displayed on them. The reels 130 are independently spun and stopped to show a set of symbols within the gaming display area 118 which may be used to determine an outcome to the game.

The display system of gaming machine 104A may also include a main display 128 (e.g., video display monitor) mounted to, or above, the gaming display area 118. The main display 128 may be, e.g., a high-resolution LCD, plasma, LED, or OLED panel which may be flat or curved as shown, a cathode ray tube, or other conventional electronically controlled video monitor. The main display 128 may be of one or more various orientations (i.e., landscape or portrait), aspect ratios and resolutions. In some implementations, the main display 128 may include a touchscreen.

In some embodiments, the bill validator 124 may also function as a ticket reader that allows the player to use a casino-issued credit ticket to load credits onto the gaming machine 104A (e.g., in a cashless ticket (“TITO”) system). In such cashless embodiments, the gaming machine 104A may also include a ticket printer 126 for outputting a credit ticket when a “cash out” button of a player interface is pressed. Cashless TITO systems may be used to generate and track unique bar-codes or other indicators printed on tickets to allow players to avoid the use of bills and coins by loading credits using a ticket reader and cashing out credits using a ticket printer 126 on the gaming machine 104A. The gaming machine 104A may have hardware meters for purposes including ensuring regulatory compliance and monitoring the player credit balance. In addition, there may be additional meters that record the total amount of money wagered on the gaming machine, total amount of money deposited, total amount of money withdrawn, and total amount of winnings on gaming machine 104A.

In some embodiments, a player tracking card reader 144, a transceiver for wireless communication with a player's smartphone, a keypad 146, and/or an illuminated display 148 for reading, receiving, entering, and/or displaying player tracking information is provided in the gaming machines 104A. In such embodiments, a game controller (not shown in FIG. 1) within the gaming machines 104A may communicate with the player tracking system server 110 to send and receive player tracking information.

The display system of gaming machine 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming machine 104A and may be activated by a player (e.g., using a switch or one of buttons 122 of a player interface) to indicate to operations staff that gaming machine 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some embodiments, the information panel(s) 152 may be implemented as an additional video display.

Gaming machines 104A have traditionally also included a handle 132 typically mounted to the side of main cabinet 116 which may be used to initiate game play.

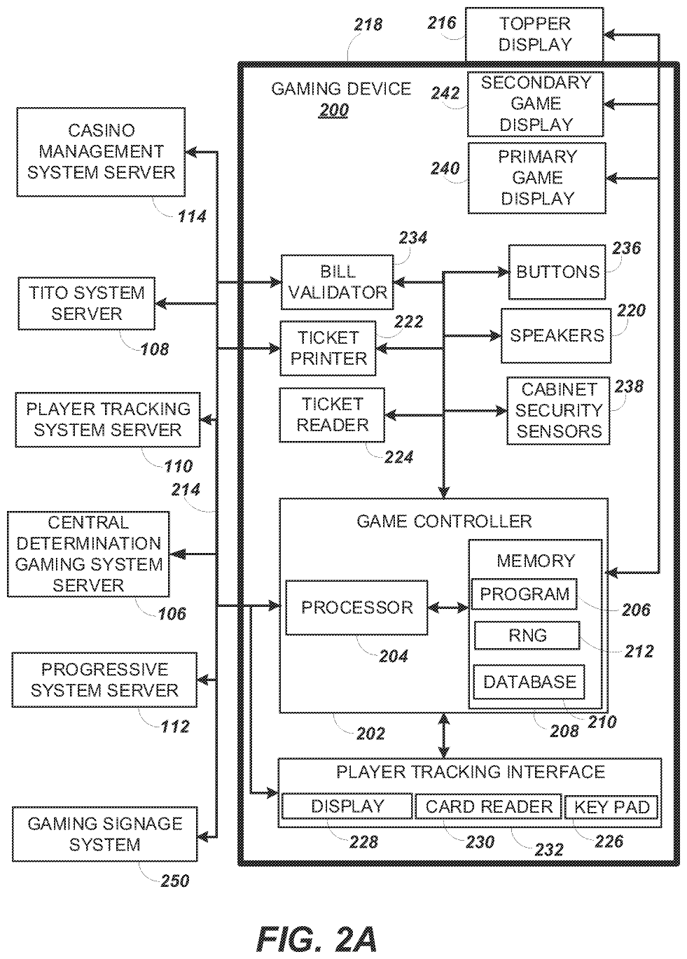

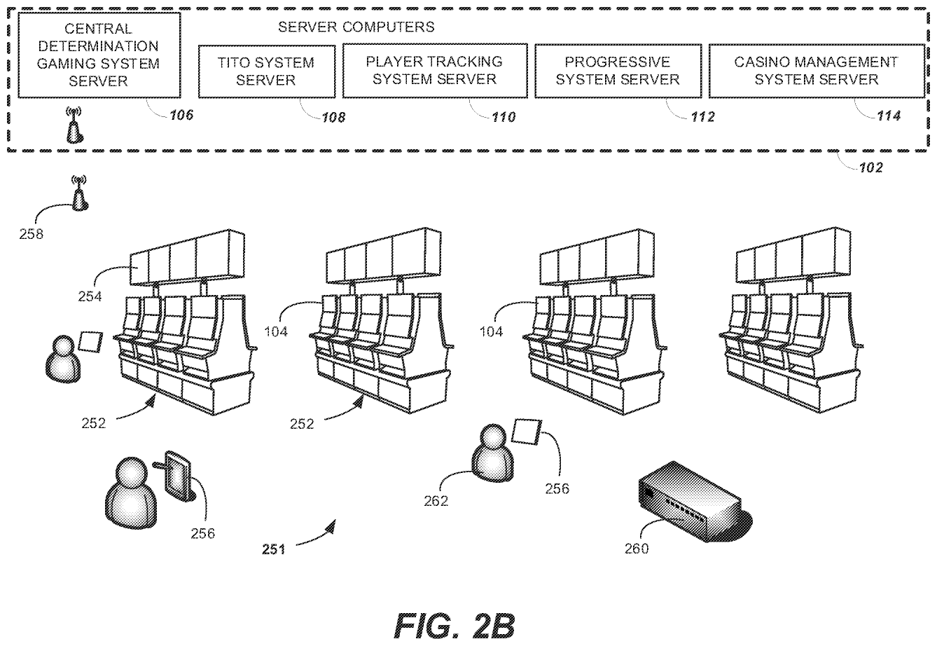

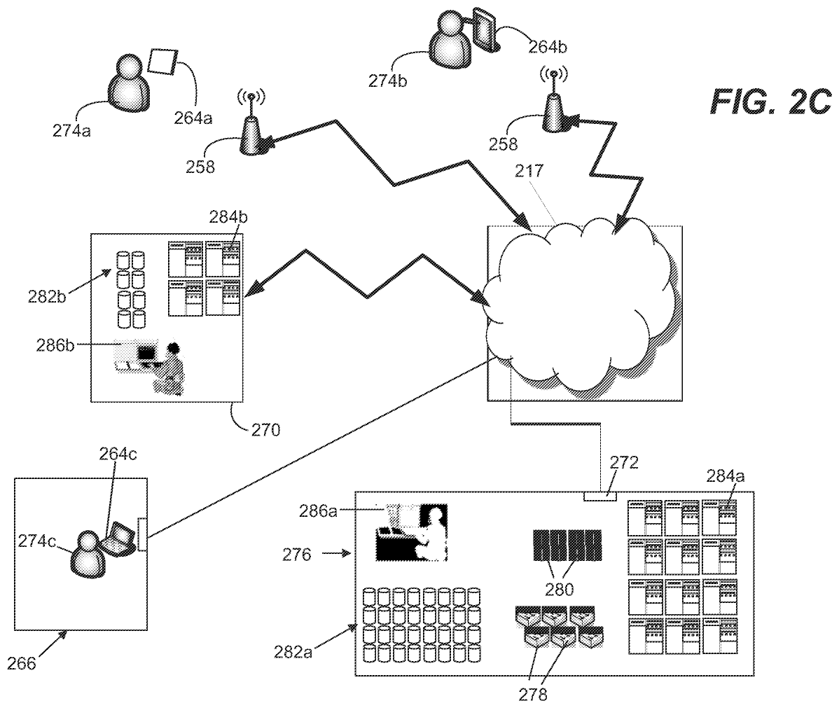

Many or all of the above-described components may be controlled by circuitry (e.g., a game controller) housed inside the main cabinet 116 of the gaming machine 104A, the details of which are shown in FIG. 2A.

Note that not all gaming machines that are suitable for implementing embodiments of the present disclosure necessarily include top wheels, top boxes, information panels, cashless ticket systems, and/or player tracking systems. Further, some suitable gaming machines may include a display system having only a single game display, which may include only a mechanical set of reels or a video display. Some suitable gaming machines may be designed for bars or table tops and have a display system comprising a display that face upwards.

An alternative example gaming machine 1048 illustrated in FIG. 1 is the Arc™ model gaming machine manufactured by Aristocrat® Technologies, Inc. Note that, where possible, reference numerals identifying similar features of the gaming machine 104A embodiment are also identified in the gaming machine 1048 embodiment using the same reference numbers. The display system of the gaming machine 104B does not include physical reels, but instead includes a main display 128 that shows game play functions. The display system may also include an optional topper screen 140. The optional topper screen 140 may be used as a secondary game display that may be used for bonus game play, to present game features or attraction activities while a game is not in play, or to present any other information or media desired by the game designer or operator. In some embodiments, topper screen 140 may also or alternatively be used to display progressive jackpot prizes available to a player during play of gaming machine 1048.

Example gaming machine 104B includes a main cabinet 116 including a service door or main door 117 which opens to provide access to the interior of the gaming machine 1048. The main door 117 is typically used by service personnel to refill the ticket printer 126 and collect bills and tickets inserted into the bill validator 124. The main door 117 may also be accessed to reset the machine, verify and/or upgrade the software, and for general maintenance operations.

Another example gaming machine 104C shown is the Helix™ model gaming machine manufactured by Aristocrat® Technologies, Inc. The display system of gaming machine 104C may include a main display 128A that is in a landscape orientation. Although not illustrated by the front view provided, the landscape-style main display 128A may have a curvature radius from top to bottom and/or from side to side. In some embodiments, main display 128A may include a flat panel display. In various embodiments, main display 128A is typically used for primary game play while secondary display 1288 of the display system is typically used for a bonus game play, to show game features or attraction activities while the game is not in play or any other information or media desired by the game designer or operator. In some embodiments, example gaming machine 104C may also include speakers 142 to output various audio such as game sound, background music, etc.

Many different types of games, including mechanical slot games, video slot games, video poker, video black-jack, video pachinko, keno, bingo, and lottery, may be provided with or implemented within the depicted gaming machines 104A-104C and other similar gaming machines. Each gaming machine may also be operable to provide many different games. Games may be differentiated according to themes, sounds, graphics, type of game (e.g., slot game vs. card game vs. game with aspects of skill), denomination, quantity of paylines, maximum jackpot, progressive or non-progressive, bonus games, and may be deployed for operation in Class II or Class III, etc.

FIG. 2A is a block diagram depicting examples of internal electronic components of a gaming machine 200 connected to various external systems. All or parts of the example gaming machine 200 shown may be used to implement any one of the example gaming machines 104A-X depicted in FIG. 1. The games available for play on the gaming machine 200 are controlled by a game controller 202 that includes one or more processors 204 and a game that may be stored as game software or a program 206 in a memory 208 coupled to the processor 204. The memory 208 may include one or more mass storage devices or media that are housed within gaming machine 200. Within the mass storage devices and/or memory 208, one or more databases 210 may be provided for use by the program 206. A random number generator (RNG) 212 that may be implemented in hardware and/or software is typically used to generate random numbers that are used in the operation of game play to ensure that game play outcomes are random and meet regulations for a game of chance.

Alternatively, a game instance (a play or round of the game) may be generated on a remote gaming machines such as the central determination gaming system server 106. The game instance may be communicated to gaming machine 200 via the network 214 and then displayed on gaming machine 200. Gaming machine 200 may execute game software, such as, but not limited to, video streaming software that allows the game to be displayed on gaming machine 200. When a game is stored on gaming machine 200, it may be loaded from the memory 208 (e.g., from a read only memory (ROM)) or from the central determination gaming system server 106 to memory 208. The memory 208 may include random access memory (RAM), ROM or another form of storage media that stores instructions for execution by the processor 204.

The gaming machine 200 may include a topper display 216 or another form of a top box (e.g., a topper wheel, a topper screen, etc.) which sits above main cabinet 218. The cabinet 218 or topper display 216 may also house a number of other components which may be used to add features to a game being played on gaming machine 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. The player tracking interface 232 may include a keypad 226 for entering information, a player tracking display 228 for displaying information (e.g., an illuminated or video display), and a card reader 230 for receiving data and/or communicating information to and from media or a device such as a smart phone enabling player tracking. Ticket printer 222 may be used to print tickets for a TITO system server 108. The gaming machine 200 may further include a bill validator 234, buttons 236 of a player interface, cabinet security sensors 238 to detect unauthorized opening of the cabinet 218, a primary game display 240, and a secondary game display 242, each coupled to and operable under the control of game controller 202.

Gaming machine 200 may be connected over network 214 to player tracking system server 110. Player tracking system server 110 may be, for example, an OASIS® system manufactured by Aristocrat® Technologies, Inc. Player tracking system server 110 is used to track play (e.g., amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

Some gaming machines, such as gaming machines 104A-104X, are highly regulated to ensure fairness and, in many cases, gaming machines 104A-104X, 200 are operable to award monetary awards (e.g., typically dispensed in the form of a redeemable voucher). Therefore, to satisfy security and regulatory requirements in a gaming environment, hardware and software architectures are implemented in gaming machines 104A-104X, 200 that differ significantly from those of general-purpose computers. Adapting general purpose computers to function as gaming machines 200 is not simple or straightforward because of: 1) the regulatory requirements for gaming machine 200, 2) the harsh environment in which gaming machines 200 operate, 3) security requirements, 4) fault tolerance requirements, and 5) the requirement for additional special purpose componentry enabling functionality of a gaming machine. These differences require substantial engineering effort with respect to game design implementation, hardware components and software.

When a player wishes to play the gaming machine 200, he/she may insert cash or a ticket voucher through a coin acceptor (not shown) or bill validator 234 to establish a credit balance on the gaming machine. The credit balance is used by the player to place wagers on instances of the game and to receive credit awards based on the outcome of winning instances. The credit balance is decreased by the amount of each wager and increased upon a win. The player may add additional credits to the balance at any time. The player may also optionally insert a loyalty club card into the card reader 230. During the game, the player may view the game outcome on the primary game display 240 and/or the secondary game display 242. Other game and prize information may also be displayed.

For each game instance, a player may make selections, which may affect play of the game. For example, the player may vary the total amount wagered by selecting the amount bet per line and the quantity of lines played. In many games, the player is asked to initiate or select options during course of game play (such as spinning a wheel to begin a bonus round or select various items during a feature game). The player may make these selections using a player interface, which may include the player input buttons 236, the primary game display 240 (which may include a touch screen), or some other device which enables a player to input information into the gaming machine 200.

During certain game events, the gaming machine 200 may display visual and auditory effects that may be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming machine 200 or from lights behind the information panel 152 (FIG. 1).

In this example, the gaming machine 200 is also configured for communication with a gaming signage system 250 via the network 214. Various examples of gaming signage systems 250 are provided herein. According to some examples, the gaming signage system 250 may be configured for communication with other elements of a gaming system via the network 214, such as the central determination gaming system server 106, the progressive system server 112, the player tracking system server 110 the casino management system server 114 and/or the TITO system server 108.

When the player is done, he/she cashes out the credit balance. For example, the player may press a cash-out button of a player interface to receive a payout from a credit payout mechanism such as ticket printer 222, player tracking interface 232, or coin hopper. The ticket printer 222 may provide a ticket, which may be redeemed for money or inserted into another machine to establish a credit balance for play. In other embodiments, the credit balance may be dispensed via a coin hopper or transferred to a card or account via player tracking interface 232.

While an example gaming machine 200 has been described in regard to FIG. 2A, certain aspects of the present disclosure may be implemented by gaming machines that lack one or more of the above-described components. For example, not all gaming machines suitable for implementing aspects of the present disclosure necessarily include top boxes, information panels, cashless ticket systems, and/or player tracking systems. Further, some suitable gaming machines may include a single game display having mechanical reels or a video display. Moreover, other embodiments may be designed for bar tables and have displays that face upwards.

Many different types of wagering games, including mechanical slot games, video slot games, video poker, video black-jack, video pachinko, keno, bingo, and lottery, may be provided by the gaming machine 200. In particular, the gaming machine 200 may be operable to provide many different instances of games of chance. The instances may be differentiated according to themes, sounds, graphics, type of game (e.g., slot game vs. card game vs. game with aspects of skill), denomination, quantity of paylines, maximum jackpot, progressive or non-progressive, bonus games, class 2 or class 3, etc.

The gaming machine 200 may allow a player to select a game of chance, skill, or combination thereof, to play from a plurality of instances available on the gaming machine 200. For example, the gaming machine 200 may provide a menu with a list of the instances of games that are available for play on the gaming machine 200 and a player may be able to select, from the list, a game that they wish to play.

FIG. 2B depicts a casino gaming environment according to one example. In this example, the casino 251 includes banks 252 of gaming machines 104. In this example, each bank 252 of gaming machines 104 includes a corresponding gaming signage system 254. According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the gaming machines 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a player interface of a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the quantities, types and arrangements of gaming machines shown in FIG. 2C are merely shown by way of example. In this example, various gaming machines, including but not limited to end user devices (EUDs) 264a, 264b and 264c are capable of communication via one or more networks 217. The networks 217 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 217. The gaming data center 276 is capable of communication with the networks 217 via the gateway 272. In this example, switches 278 and routers 280 are configured to provide network connectivity for devices of the gaming data center 276, including storage devices 282a, servers 284a and one or more workstations 286a. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 217. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 217. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

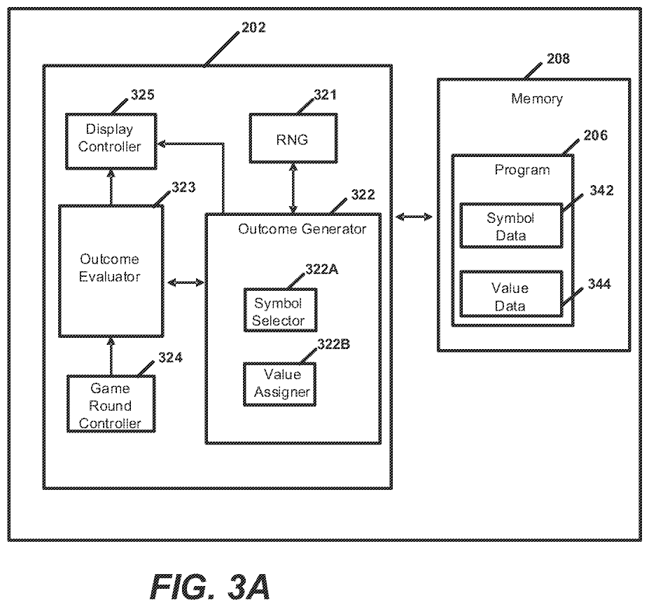

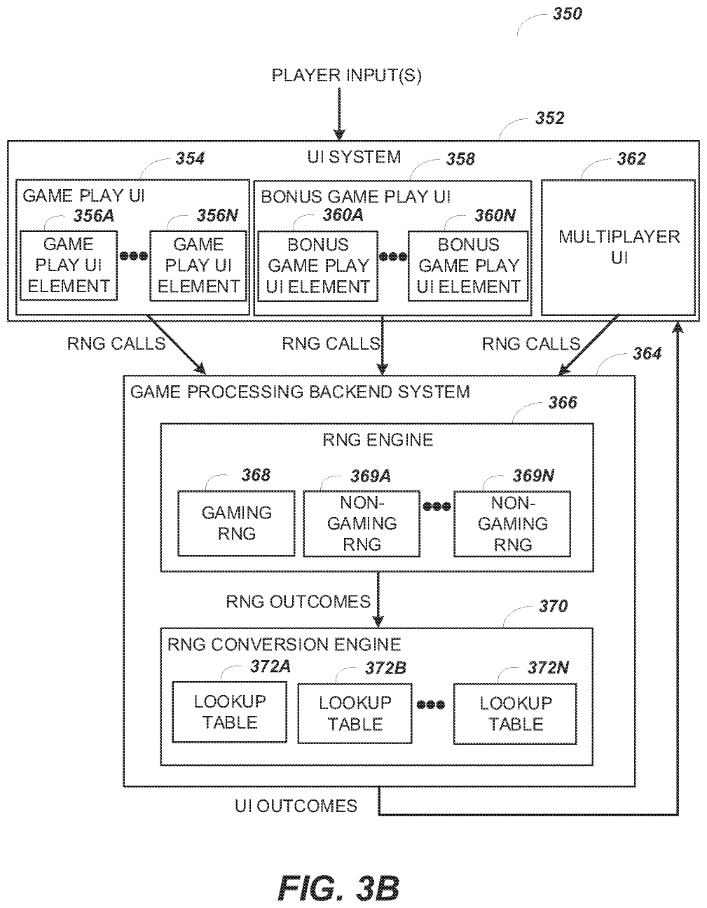

In FIG. 3A, the processor 204 of game controller 202 of gaming machine 200 is shown implementing a number of modules based on a program 206 stored in memory 208. Persons skilled in the art will appreciate that several of the modules could be implemented in some other way, for example, by a dedicated circuit. The game controller 202 is an example of what may be referred to herein as a “control system.” In some implementations, the control system may also include the memory 208. Other examples of control systems are disclosed herein.

According to this example, these modules include an outcome generator 322 which operates in response to the player's operation of player input buttons of a player interface to place a wager and initiate a play of the game and generates a game outcome which will then be evaluated by outcome evaluator 323. In some examples, the first part of forming the game outcome may be for a symbol selector 322A to select symbols from a set of symbols specified by symbol data 342 using a random number generator (RNG) 321. The selected symbols may be advised to the display controller 325, which causes them to be displayed as a symbol display on primary game display at a set of display positions.

In certain embodiments, the symbol data 342 includes one or more virtual reels that correspond to one or more reels displayed by the primary game display. The virtual reels may include an arrangement of symbols selected from symbol data 342 in, for example, a predetermined or random manner. The symbol selector 322A may select a stop position for the one or more virtual reels based on one or more outcomes of the RNG 321. The stop position of the one or more reels then determines the symbols that are presented on the primary game display. In some alternative implementations, the functionality of one or more of the modules shown in FIG. 3A may be implemented in another device, e.g., in a server. For example, the functionality of the RNG 321, the outcome generator 322, the outcome evaluator 323 and/or the game round controller 324 may be implemented in a device that is configured for communication with the gaming machine 200.

FIG. 3B illustrates, in block diagram form, an embodiment of a game processing architecture 350 that implements a game processing pipeline for the play of a game in accordance with various embodiments described herein. As shown in FIG. 3B, the gaming processing pipeline starts with having a UI system 352 receive one or more player inputs for the game instance. Based on the player input(s), the UI system 352 generates and sends one or more RNG calls to a game processing backend system 364. Game processing backend system 364 then processes the RNG calls with RNG engine 366 to generate one or more RNG outcomes. The RNG outcomes are then sent to the RNG conversion engine 370 to generate one or more game outcomes for the UI system 352 to display to a player. The game processing architecture 350 may implement the game processing pipeline using a gaming machine, such as gaming machines 104A-104X and 200 shown in FIGS. 1 and 2A, respectively. Alternatively, portions of the gaming processing architecture 350 may implement the game processing pipeline using a gaming machine and one or more remote gaming machines, such as central determination gaming system server 106 shown in FIG. 1.

The UI system 352 includes one or more UIs that a player may interact with. The UI system 352 could include one or more game play UIs 354, one or more bonus game play UIs 358, and one or more multiplayer UIs 362, where each UI type includes one or more mechanical UIs and/or graphical UIs (GUIs). In other words, game play UI 354, bonus game play UI 358, and the multiplayer UI 362 may utilize a variety of UI elements, such as mechanical UI elements (e.g., physical “spin” button or mechanical reels) and/or GUI elements (e.g., virtual reels shown on a video display or a virtual button deck) to provide a player interface that receives player inputs and/or presents game play to a player. Using FIG. 3B as an example, the different UI elements are shown as game play UI elements 356A-356N and bonus game play UI elements 360A-360N.

The game play UI 354 represents a UI that a player typically interfaces with for a base game. During a game instance of a base game, the game play UI elements 356A-356N (e.g., GUI elements depicting one or more virtual reels) are shown and/or made available to a user. In a subsequent game instance, the UI system 352 could transition out of the base game to one or more bonus games. The bonus game play UI 358 represents a UI that utilizes bonus game play UI elements 360A-360N for a player to interact with and/or view during a bonus game. In one or more embodiments, at least some of the game play UI element 356A-356N are similar to the bonus game play UI elements 360A-360N. In other embodiments, the game play UI element 356A-356N may differ from the bonus game play UI elements 360A-360N.

FIG. 3B also illustrates that UI system 352 could include a multiplayer UI 362 purposed for game play that differs or is separate from the typical base game. For example, multiplayer UI 362 could be set up to receive player inputs and/or presents game play information relating to a tournament mode. When a gaming machine transitions from a primary game mode that presents the base game to a tournament mode, a single gaming machine is linked and synchronized to other gaming machines to generate a tournament outcome. For example, multiple RNG engines 366 corresponding to each gaming machine could be collectively linked to determine a tournament outcome. To enhance a player's gaming experience, tournament mode may modify and synchronize sound, music, reel spin speed, and/or other operations of the gaming machines according to the tournament game play. After tournament game play ends, operators may switch back the gaming machine from tournament mode to a primary game mode to present the base game. Although FIG. 3B does not explicitly depict that multiplayer UI 362 includes UI elements, multiplayer UI 362 could also include one or more multiplayer UI elements.

Based on the player inputs, the UI system 352 could generate RNG calls to a game processing backend system 364. As an example, the UI system 352 could use one or more application programming interfaces (APIs) to generate the RNG calls. To process the RNG calls, the RNG engine 366 could utilize gaming RNG 368 and/or non-gaming RNGs 369A-369N. Gaming RNG 368 corresponds to RNG 212 shown in FIG. 2A. As previously discussed with reference to FIG. 2A, gaming RNG 368 often performs specialized and non-generic operations that comply with regulatory and/or game requirements. For example, because of regulation requirements, gaming RNG 368 could be a cryptographic random or pseudorandom number generator (PRNG) (e.g., Fortuna PRNG) that securely produces random numbers for one or more game features. To generate random numbers, gaming RNG 368 could collect random data from various sources of entropy, such as from an operating system (OS) and/or a hardware based RNG (not showing in FIG. 3B). Alternatively, non-gaming RNGs 369A-369N may not be cryptographically secure and/or be computationally less expensive. Non-gaming RNGs 369A-369N may, thus, be used to generate outcomes for non-gaming purposes. As an example, non-gaming RNGs 369A-369N may generate random numbers for such as generating random messages that appear on the gaming machine.

The RNG conversion engine 370 processes each RNG outcome from RNG engine 366 and converts the RNG outcome to a UI outcome that is feedback to the UI system 352. The RNG conversion engine 370 corresponds to RNG 212 of FIG. 2A used for game play. As previously described, RNG conversion engine 370 translates the RNG outcome from the RNG 368 to a game outcome presented to a player. RNG conversion engine 370 utilizes one or more lookup tables 372A-372N to regulate a prize payout amount for each RNG outcome and how often the gaming machine pays out the derived prize payout amounts. In one example, the RNG conversion engine 370 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game. In various embodiments, RNG 368 could be a physical device such as a co-processor with memory that executes instructions to generate random numbers. In certain embodiments, RNG 368 could be implemented in processor 204.

After generating the UI outcome, the game processing backend system 364 sends the UI outcome to the UI system 352. Examples of UI outcomes are symbols to display on a video reel or reel stops for a mechanical reel. In one example, if the UI outcome is for a base game, the UI system 352 updates one or more game play UI elements 356A-356N, such as symbols, for the game play UI 354. In another example, if the UI outcome is for a bonus game, the UI system could update one or more bonus game play UI elements 360A-360N (e.g., symbols) for the bonus game play UI 358. In response to updating the appropriate UI, the player may subsequently provide additional player inputs to initiate a subsequent game instance that progresses through the game processing pipeline.

Hold and Spin Game with Persistent Symbol Display Zones

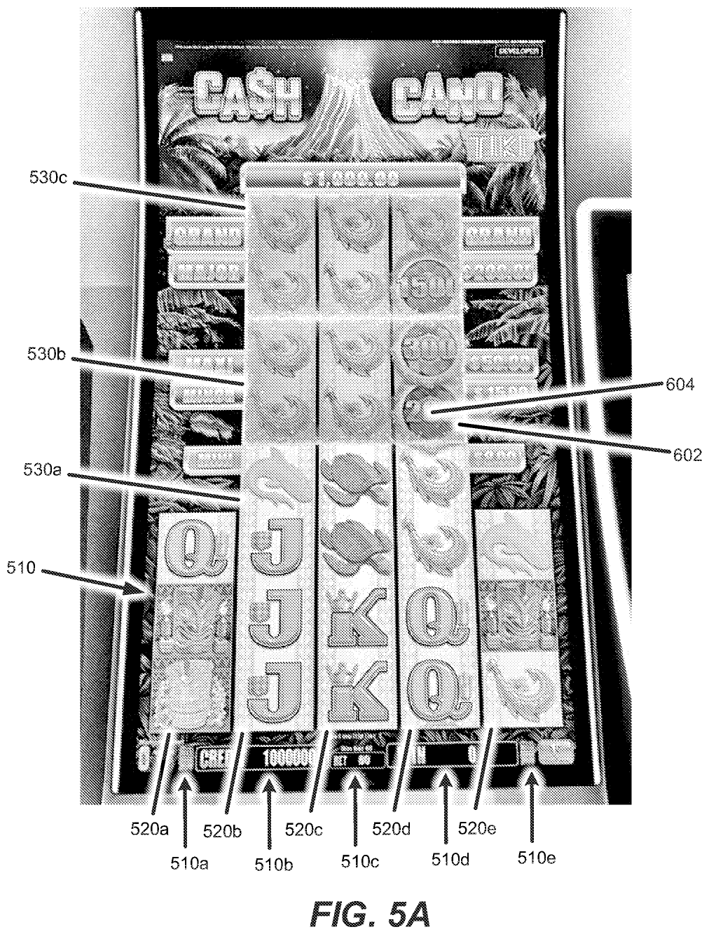

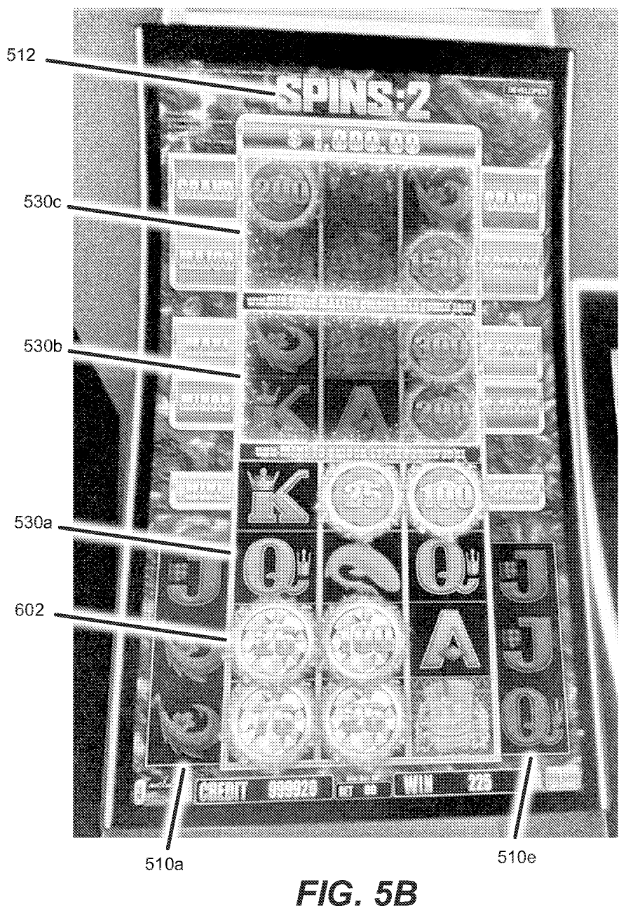

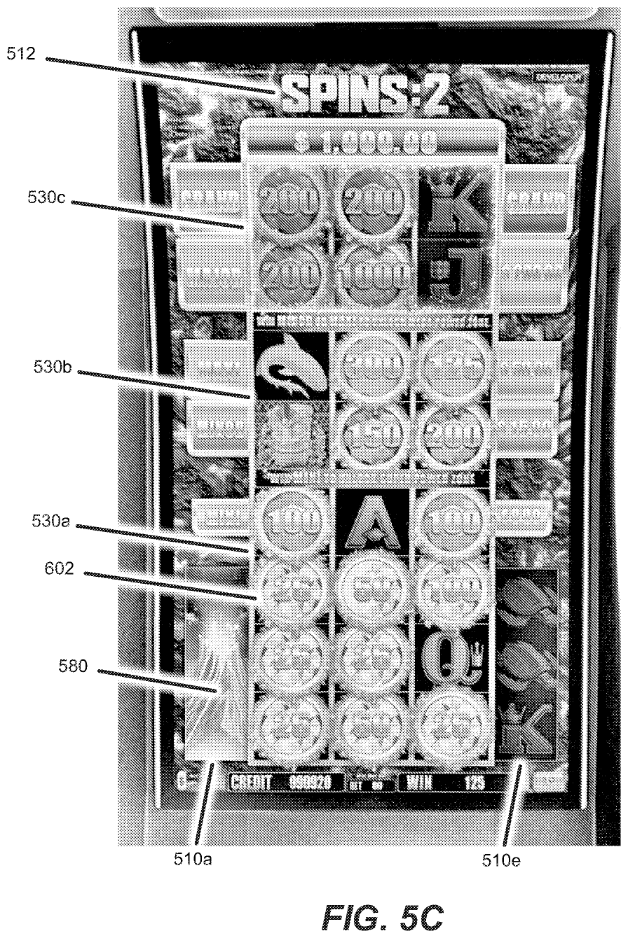

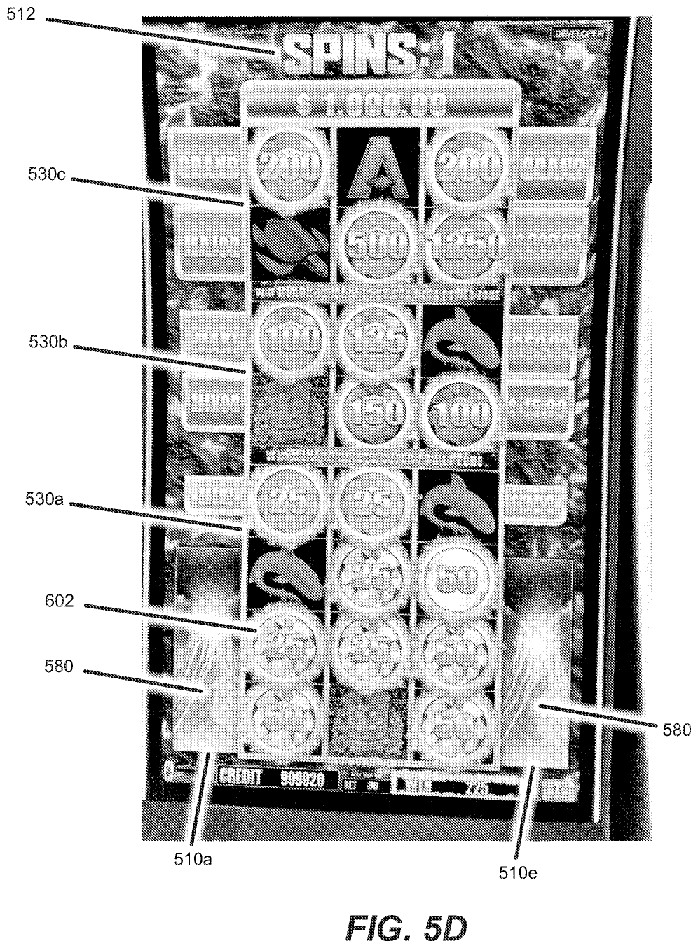

In the embodiment described below, the display positions of the symbol display are arranged in a matrix comprising a plurality of columns and a plurality of rows. In some embodiment, the symbol display may be rectangular matrix (e.g., 3×5, 4×6, etc.). In other embodiments, such as those shown in FIGS. 5A-5D, some columns may include a greater number of symbols than others. For example, as shown in FIG. 5A, a base game display matrix has a 3-4-4-4-3 arrangement of eighteen display positions, in which a first reel and a fifth reel each display three symbols, and in which a second reel, a third reel, and a fourth reel each display four symbols. As further, depicted in FIG. 5A, the base game may further present one or more persistent symbol display zones of display positions. The persistent symbol display zones may be positioned above the base game display matrix.

In FIG. 5A, the persistent symbol display zones provide a 3×4 matrix of display positions. In particular, the twelve display positions of the persistent symbol display zones are presented above the eighteen display positions of the base game display matrix. Moreover, in one embodiment, each of the twelve display positions of the persistent symbol display zones has its own a separate reel associated therewith. Thus, in such embodiment, twelve reels populate the twelve display positions of the persistent symbol display zones. This is in contrast with the base game display matrix in which the eighteen display positions are populated with symbols from five reels. In particular, each of the five reels populates its respective column of symbol display positions with symbols. Having individual reels that correspond to the twelve display positions in the persistent symbol display zones allows additional control to the game designer to provide higher symbol values at the display positions in the persistent symbol display zones while balancing the return-to-player of the game.

In various embodiments, each column of the persistent symbol display zone may correspond to a single reel. In various embodiments, the quantity of symbols, or arrangement of symbols in various columns and rows may be altered.

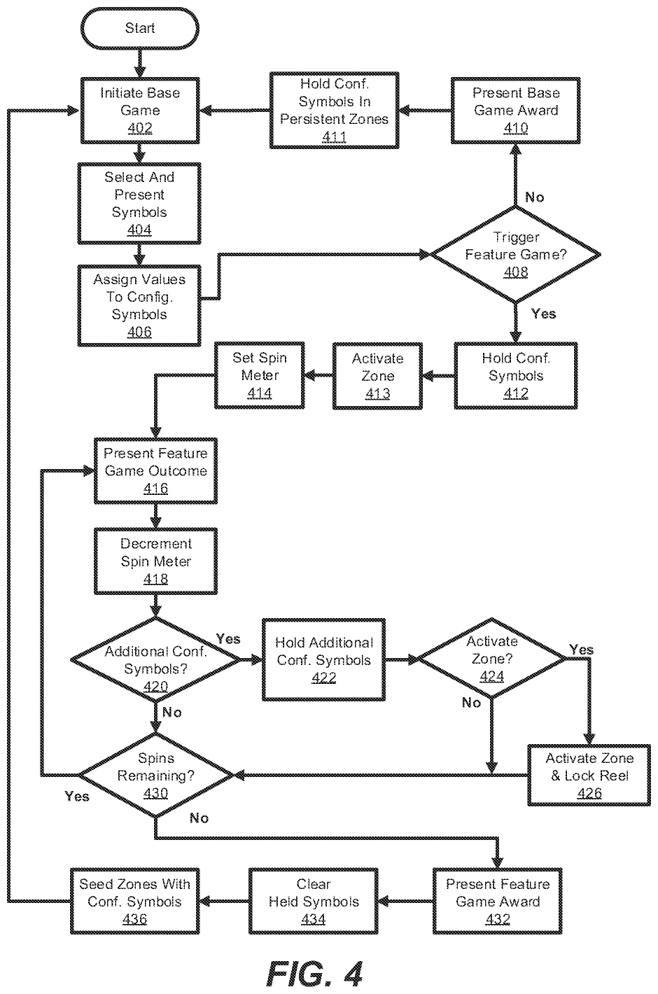

FIG. 4 provides a flowchart depicting operation of one embodiment of a gaming machine 200. Per the flowchart of FIG. 4, the gaming machine may provide a base game with persistent symbol display zones and a hold and spin game. To simplify the following discussion, the game controller 202 provides an initial quantity of spins to the hold and spin game. However, other terms such as games, rounds, instances, etc. may be more appropriate than the term spin for other games. Thus, references to spins should be interpreted to include games, rounds, instances, etc. with respect to these other games. Moreover, while the hold and spin game may be implemented as a feature game whose play is triggered or initiated based on play of a base game, the hold and spin game or aspects thereof may be part of another game such as a base game, free game, etc. and/or may be initiated without regard to play of a base game.

As shown, the game controller 202 at 402 may initiate play of the base game in response to receiving input from a player interface of the gaming machine 200. In response to initiating play of the base game, a symbol selector 322A (see, e.g., FIG. 3A) of the game controller 202 at 404 may select a plurality of symbols from a set of symbols and the game controller 202 may display first symbols from the selected plurality of symbols at the respective display positions of the base game display matrix and second symbols from the plurality of symbols at respective display positions of the persistent symbol display zones.

More specifically, referring to FIG. 5A, the gaming machine 200 at 404 may present symbols in a base game display matrix 510 that includes a first column 510a of three symbol display positions, a second column 510b of four symbol display positions, the third column 510c of four symbol display positions, a fourth column 510d of four symbol display positions, and a fifth column 510e of three symbol display positions. During the base game of one embodiment, a first reel 520a populates the first column 510a with symbols, a second reel 520b populates the second column 510b with symbols, a third reel 520c populates the third column 510c with symbols, a fourth reel 520d populates the fourth column 510d with symbols, and a fifth reel 520e populates the fifth column 510e with symbols. The eighteen symbols presented by the reels 520a-520e in the base game display matrix 510 may define a base game outcome for which the gaming machine 200 may award base game prizes.

In addition to the base game display matrix 510, the gaming machine 200 at 404 may also populate or update the display positions of a persistent symbol display matrix 530. As shown, the persistent symbol display matrix may include a first persistent symbol display zone 530b and a second persistent symbol display zone 530c, which are presented above the base game display matrix 510 in FIG. 5A. As shown in FIG. 5A, each of the persistent symbol display zones 530b, 530c includes six symbol display positions arranged in a 2×3 matrix of two rows with three columns. In the depicted embodiment, each of the persistent symbol display zones 530b, 530c includes six reels which each populate a single display position of its respective zone 530b, 530c. Due to such an arrangement, each symbol in persistent symbol display zones 530b, 530c may be updated separately. In various embodiments, each column of the persistent symbol display zone 530b and 530c corresponds to a single reel instead of individual reels for each symbol display position. Therefore, in the above example persistent symbol display zone 530b would have 3 reels and persistent symbol display zone 530c would also have 3 reels.

In particular, the gaming machine 200 at 404 only updates or generates replacement symbols for each display position in persistent symbol display zones 530b, 530c that does not display a configurable symbol. For example, the gaming machine 200 may hold or lock each reel that presents a configurable symbol in zones 530b, 530c and spin the remaining reels in zones 530b, 530c to select and present replacement symbols at the respective display positions. In various embodiments, configurable symbols displayed in the persistent symbol display zone may only be held if an additional condition is met. This condition may be tied to a game outcome, e.g., the base game outcome (a symbol or symbol combination being displayed in the base game outcome), a random occurrence, a threshold being met, etc.

In additional to the two persistent symbol display zone 530b, 530c, the base game display matrix 510 includes a symbol display zone 530a comprising a subset of the display positions in the base game display matrix 510. In particular, the symbol display zone 530a includes the twelve display positions populated by the second, third, and fourth reels 520b, 520c, 520d.

In one embodiment, for each play or spin of the base game, the game controller 202 at 404 may spin the five reels 520a-520e associated with the base game display matrix 510 and each of the reels associated with the persistent symbol display zones 530b, 530c without a configurable symbol to select the symbols from a set of symbols stored as symbol data 342 in memory 208. The set of symbols may include both configurable symbols and non-configurable symbols. In an embodiment, the configurable symbols each comprise at least a common component and at least a variable component. The variable component may indicate a value of a prize that is associated with each of the configurable symbols.

An example of a configurable symbol is shown in FIGS. 5A-5D in the form of a coin symbol 602. In such embodiment, the common component is the coin symbol 602 itself, while the variable component is the indicia 604 overlaying coin symbol 602. In this case, indicia are numerals directly indicative of the numeric value of the prize. In other embodiments, the indicia may indirectly indicate the numeric value of the prize.

At 406, the game controller may assign values to any configurable symbols newly added to the base game display matrix 510 and the persistent symbol display zones 530b, 530c In some embodiments, at least one value of the respective prizes is generated by randomly selecting one of a plurality of defined multipliers that is applied to an amount wagered on the base game from which the feature is game triggered. To this end, value assigner 322B in some such embodiments selects the predefined multipliers from value data 344 using a value obtained from the RNG 321, applies the multiplier to the initial wager to obtain a prize value, and assigns the prize value to each of the configurable symbols selected by symbol selector 322A. The plurality of defined multipliers in some such embodiments may be selected at random according to a weighted probability based at least in part on the amount wagered on the base game. That is, the value assigner 322B may obtain a value from RNG 321 and may use this value to determine from the weighted table which value to assign to a configurable symbol. In an embodiment, the assignment of values to the configurable symbols is performed by the value assigner 322B after the symbols have been selected and the game controller knows they will be displayed but before they are displayed on the display. In another embodiment, the assignment occurs after the symbols have been displayed on display 240. In another embodiment, values are assigned to all configurable symbols irrespective of whether they will be displayed. In this manner, the value assigner 322B may scale the values assigned to the configurable symbols based on the wager.

At 408, the outcome evaluator 323 of the game controller 202 may monitor play of the base game and determine whether a trigger event has occurred. In one embodiment, a trigger event occurs when each column of the symbol display zone 530a includes a configurable symbol. In various embodiments, the reels 520a, 520c, 520d that are used to populate columns 510b, 510c, and 510d include configurable symbols, while reels 520a and 520e used to populate columns 510a and 510e do not contain any configurable symbols. In such embodiments, the game controller 202 may only present configurable symbols in columns 510b, 510c, and 510d since the reels 520a, 520e for the other columns 510a, 510e lack configurable symbols to present. In such an embodiment, a trigger event occurs when each of the second reel 520b, the third reel 520c, and the fourth reel 520d includes at least one configurable symbol. However, in some embodiments, other base game outcomes presented in the base game display matrix 510 may trigger the hold and spin feature game. For example, certain symbol combinations may trigger the feature game regardless of the number of configurable symbols presented in the base game display matrix 510. Additionally and/or alternatively, the game controller 202 may trigger the feature game when at least a threshold number of configurable symbols (e.g., six) are presented in one or more of symbol display zones 530a, 530b, or 530c, or the base game display matrix 510 regardless of their position within the respective zone or matrix.

If a trigger event has not occurred, the game controller 202 at 410 may determine and present awards for any winning symbol combinations in the base game display matrix 510. Furthermore, the game controller at 411 may hold or lock each reel in the persistent symbol display zones 530b, 530c that includes a configurable symbol before returning to 402 for further plays of the base game. In this manner, the configurable symbols in persistent symbol display zone 530b, 530c may persist and accumulate across plays of the base game.

However, if a trigger event does occur, the game controller 202 may initiate a feature game and may present base game awards if any. In some embodiments, the game controller 202 may simply add any base game awards to a win meter and present such base game awards with any feature game awards at 432. In response to initiating the feature game, the game controller 202 at 412 may hold each configurable symbol in the symbol display zone 530a of the base game display matrix 510 at its respective display position as well as each configurable symbol in the persistent symbol display zones 530b, 530c. See, e.g., FIG. 5B. As shown in FIG. 5B, each of the second column 510b, of the third column 510c, and fourth column 510d of the base game display matrix 510 includes a configurable symbol and thus causes a trigger event in various embodiments.

Moreover, as shown in FIG. 5B, the game controller 202 further activates symbol display zone 530a for the play of the feature game, while persistent symbol display zone 530b, 530c remain inactive. In one embodiment, only configurable symbols in activated symbol display zones 530a, 530b, 530c are awarded to the player at the end of the feature game. During the course of the feature game, the player may activate persistent symbol display zones 530b, 530c so as to obtain the awards depicted by the configurable symbols in those areas. In one embodiment, a zone is activated in response to the first reel 520a or the fifth reel 520e presenting a predetermined zone activation symbol 580 (e.g., volcano symbols of FIGS. 5C and 5D). In some embodiments, persistent symbol display zones 530b, 530c may be activated when the feature game is triggered. The trigger condition to activate the zones may be the same as the condition to activate the zones during the play of the hold and spin game.

The game controller 202 at 414 may set a spin meter 512 to the initial quantity of games. For example, in an embodiment, the game controller 202 may set the spin meter 512 to a predetermined value (e.g., 3, 4, 5, etc.) In some embodiments, the spin meter 512 may be set based on symbols in the base game display matrix 510. For example, the game controller 202 may set the spin meter 512 to a value equal to the quantity of configurable symbols in the base game display matrix 510 upon triggering of the feature game.

At 416, the outcome generator 322 of the game controller 202 may present a feature game outcome on display 240. In one embodiment, each symbol position of the symbol display zone 530a during the feature game is populated by a separate reel. Thus, in the examples presented in FIGS. 5B-5D, the symbol display zone 530a includes twelve reels and each reel populates one display position of the symbol display zone 530a. While the second reel 520b, the third reel 520c, and the fourth reel 520d of the base game are replaced with twelve individual reels in the feature game, the first reel 520a and the fifth reel 520d continue to populate their respective three display positions. However, different reel strips may be used for the first reel 520a and the fifth reel 520e during the feature game than are used for such reels during the base game. In particular, during the base game, the reel strips for the first reel 520a and fifth reel 520e lack the predetermined zone activation symbol 580, but include one or more instances of the predetermined zone activation symbol during the feature game. As such, in one embodiment, the persistent symbol display zones 530b, 530c may only be activated during the feature game. However, in some embodiments, the reel strips used during the base game may include the predetermined zone activation symbol 580 in order to permit activating the zones 530b, 530c during the base game. In certain embodiments, configurable symbols may only be held in the persistent symbol display zones when these zones are active.

Similar to the base game, the symbol selector 322A may select symbols from symbol data and cause the selected symbols to be displayed at display positions of symbol display zones 530a, 530b, 530c that do not already display a configurable symbol. Note that in certain embodiments, the symbol selector 322A may select symbols for the feature game outcome from a full set of available symbols (e.g., the full set of symbols defined by symbol data 342) including any configurable symbols. In other embodiments, the symbol selector 322A may select the symbols for the feature game outcome from a reduced set of symbols that take into account any configurable symbols already held. For example, in one or more embodiments, only configurable symbols and blank symbols may be available for selection for symbol display positions of symbol display zones 530a, 530b, 530c. In other words, the reel strips for the feature game may contain only configurable symbols and blank symbols (e.g., positions without any symbol). In an alternative embodiment, the symbols may be selected from an increased set of symbols. For example, symbols may be purchased, awarded, or otherwise added to one or more the reel strips prior to initiating the feature game or spin of the feature game. If one or more configurable symbols are selected, in this example, the value assigner 322B of the game controller 202 may assign randomly selected values to each configurable symbol at 416.

At 416, the symbol selector 322a may further select symbols for the first reel 520a and the fifth reel 520e based on feature game reel strips for such reels. In this manner, predetermined zone activation symbols 580 may be presented on the first reel 520a and the fifth reel 520e during the feature game.

After presenting the feature game outcome, the game controller 202 at 418 may decrement the spin meter 512 by a defined amount, such as one (1). In some embodiments, the game controller 202 may decrement the spin meter 512 by the defined amount (e.g., one (1)), regardless of whether a configurable symbol is displayed.

The outcome evaluator 323 at 420 may monitor play of the feature game and determine whether the symbol selector 322A selected an additional configurable symbol at 416 for the feature game outcome. If the outcome evaluator 323 determines that at least one additional configurable symbol was selected by the symbol selector 322A and added to the feature game outcome, then the game controller 202 at 422 may hold each of the additional configurable symbols at their respective display positions in symbol display zones 530a, 530b, 530c regardless of whether the respective symbol display zone has been activated. Moreover, in various embodiments, the outcome evaluator 323 at 422 may further reset the spin meter 512 in response to adding at least one additional configurable symbol. In some embodiments, the spin meter 512 may be reset to the same quantity of spins as originally provided to the feature game. In other embodiments, the spin meter 512 may be reset to a predetermined value (e.g., three), reset to a value determined from symbols in the base game or feature game outcomes, may be incremented by a predetermined value (e.g., three), or may be incremented by a value from symbols in the base game or feature game outcomes.

The outcome evaluator 323 at 424 may further determine whether a trigger occurred to activate persistent symbol display zones 530b or 530c, such as when the symbol selector 322A selected a predetermined zone activation symbol 580 for the first reel 520a or the fifth reel 520e to present in its respective column of symbols. If the outcome evaluator 323 determines that either the first reel 520a and/or the fifth reel 520e is presenting an instance of the predetermined zone activation symbol 580, the game controller 202 at 426 may activate the next persistent symbol display zone 530b, 530c and optionally lock the reel with the predetermine zone activation symbol. As shown in FIG. 5C, the zone 530b has been activated due to the predetermined zone activation symbol on the first reel 520a. Such activation may be shown in various manners such as highlighting or otherwise enhancing the display of configurable symbols in activated persistent symbol display zones. As further shown in FIG. 5C, the first reel is locked and will not be further spun for the remainder of the feature game. Again such a locked state may be depicted in various manners such as increasing or growing the predetermined zone activation symbol 580 to fill all display positions associated with the first reel 520a. FIG. 5D depicts the zone 530c activated and the fifth reel 520e locked due to the predetermined zone activation symbol 580 presented by the fifth reel 520e.

In certain embodiments, zone 530c may not be activated unless zone 530b has been activated, regardless of whether the trigger condition to activate persistent symbol display zone 530c has occurred (predetermined zone activation symbol 580 present on fifth reel 520e). In some of these embodiments, the predetermined zone activation symbol 580 may be locked on reel 520e and may remain locked until either the feature play is over, or the trigger condition for activation of zone 530b occurs (predetermined zone activation symbol 580 present on first reel 520a). When that occurs, both zones 530b and 530c may be activated. In some other embodiments, the predetermined zone activation symbol 580 may not be held on reel 520e and reel 520e may be spun for the next play of the feature game.

In some embodiments, there may not be a predetermined zone activation symbol. Instead, persistent symbol display zone 530b may be activated when a certain trigger condition is met in connection with persistent symbol display zone 530a. For example, persistent symbol display zone 530b may be activated if the topmost row of all three columns (or some other set of display positions) of the persistent symbol display zone 530a is populated with a configurable symbol. Similarly, persistent symbol display zone 530c may be activated when a certain trigger condition is met in connection with persistent symbol display zone 530b. For example, persistent symbol display zone 530c may be activated if the topmost row of all three columns (or some other set of display positions) of the persistent symbol display zone 530b is populated with a configurable symbol.

In some embodiments, persistent symbol display zones 530b, 530c may be activated based on a quantity of held configurable symbols in symbol display zone 530a. In various embodiments, the persistent symbol display zones 530b, 530c may be activated based on a total quantity of configurable symbols held by zones 530a, 530b, 530c. Moreover, the persistent symbol display zone 530b may be activated in response to a first quantity of held configurable symbols and the persistent symbol display zone 530c may be activated in response to a second quantity of held configurable symbols, wherein the second quantity is greater than the first quantity. For example, zone 530b may be activated when the first quantity of configurable symbols are held during play of the hold and spin feature game in zone 530a. Further, zone 530c may be activated when the second quantity of configurable symbols are held in zone 530b and/or 530a.

In various embodiments, the activating of zones 530b, 530c based on the quantity of held symbols may be an additional trigger condition. In such embodiments, the game controller 202 may also activate zones 530, 530c in response to the predetermined zone activation symbol 580 and/or in response to filling a topmost row of a lower zone 530a, 530b as described above.

At 430, the game controller 202 may determine whether the feature game has any spins remaining. If game controller 202 determines that spins remain (e.g., spin meter 512 not equal to zero), the game controller 202 at 432 may present a feature game award for configurable symbols presented in activated symbol display zones 530a, 530b, 530c. In one embodiment, the game controller 202 at 432 presents an award equal to the sum of numeric values displayed by each of the configurable symbols in the activated symbol display zones 530a, 530b, 530c. For example, if the situation shown in FIG. 5B were the final feature game outcome, the game controller 202 at 432 would present an award of 350 credits for the six configurable symbols shown in the activated symbol display zone 530a. The award would not include the values on the four configurable symbols shown in persistent symbol display zones 530b, 530c since such zones are inactive. The game controller 202 may add such awarded values to a win meter before transferring the credits of the win meter to a credit meter.

In addition to the numeric values shown on the configurable symbols of activated symbol display zones 530a, 530b, 530c, the game controller 202 may further award prizes associated with completely filling certain rows of in activated persistent symbol display zones. As shown in FIGS. 5B-5D and counting from the bottom to the top, a Grand prize is associated with the eighth row, a Major prize is associated with the seventh row, a Maxi prize is associated with the sixth row, a Minor prize is associated with the fifth row, and a Mini prize is associated with the fourth row. The game controller 202 awards such prizes if the respective zone is activated and the respective row is filled with configurable symbols. For example, per the game outcome shown in FIG. 5C, the player is one configurable symbol short of winning the Minor prize of $15 since the persistent symbol display zone 530b is active. Further referring to FIG. 5C, the player need to not only obtain an additional configurable symbol, but also needs to activate the persistent symbol display zone 530c to win the Grand prize.

Optionally, after presenting the award or as part of the presentation of the award, the game controller 202 may clear all persistent symbol display zones 530b, 530c of configurable symbols, regardless of whether the respective persistent symbol display zone 530b, 530c was activated. By clearly configurable symbols regardless of activation of persistent symbol display zones 530b, 530c, the game controller 202 may present higher values and/or more configurable symbols in persistent symbol display zones 530b, 530c during the base game and/or the feature game since such values are not guaranteed to be awarded to the player.

After clearing the persistent symbol display zones 530b, 530c, the game controller 202 at 436 may randomly seed the persistent symbol display zones 530b, 530c with configurable symbols. In some embodiments, the game controller 202 ensures that the persistent symbol display zones 530b, 530c are collectively seeded with at least one configurable symbol. In other embodiments, the game controller 202 ensures that the persistent symbol display zones 530b, 530c are collectively seeded with at least a predetermined minimum of configurable symbols (e.g., two) and no more than a predetermined maximum of configurable symbols (e.g., four). After seeding the persistent symbol display zones 530b, 530c, the game controller 202 may return to 402 for further plays of the base game.

### Example Play

Referring now to FIGS. 5A-5D, an example play-through will be described. At FIG. 5A, a player initiates play of the base game, which causes the game controller 202 to spin the five reels 520a-520e of the base game display matrix 510 as well as the nine reels not displaying configurable symbols in the persistent symbol display zones 530b, 530c. FIG. 5B depicts that such a spin resulting in six configurable symbols being displayed in symbol display zone 530a, thus triggering the feature game. The triggering base game spin further caused an additional configurable symbol to be added to persistent symbol display zone 530c. Upon triggering the feature game, the game controller 202 set the spin meter 512 to two (2) and activated the symbol display zone 530a.

In response to the player initiating the feature game from FIG. 5B, the game controller 202 spins the first reel 520a, the fifth reel 520e, the five reels of symbol display zone 530a without configurable symbols, the four reels of zone 530b without configurable symbols, and the four reels of zone 530b without configurable symbols. Such feature game spin resulted in the first reel 520a presenting a predetermined zone activation symbol 580 as shown at FIG. 5C. Such presentation of the zone activation symbol 580 caused the game controller 202 to activate persistent symbol display zone 530b and lock the first reel 520b. The spun reels further added three configuration symbols to symbol display zone 530a, two configurable symbols to zone 530b, and two configurable symbols to zone 530c. Of note, the spin meter 512 was not decremented. In one embodiment, the game controller 202 does not decrement the spin meter 512 if the spun reels resulted in at least one configurable symbol being added to a symbol display zone 530a, 530b, 530c. In some embodiments, the game controller 202 requires at least one configurable symbols be added to an activated symbol display zone 530a, 530b, 530c in order to forego decrementing the spin meter 512.

FIG. 5D depicts an alternative outcome initiating the feature game from FIG. 5B. Of note, both the first reel 520a and the fifth reel 520e present zone activation symbols 580, which cause the game controller 202 to lock reels 520a, 520e and activate persistent symbol display zones 530b, 530c.

In various embodiments, the display matrix may be different for the play of the base game than for the feature game. In various embodiments, the symbol set for the base game may differ from the symbol set for the feature game. For example, the base game symbol set may include other traditional symbols used as non-configurable symbols, whereas the feature game symbol set may only have configurable symbols and one type of non-configurable symbol, such as a blank symbol.

Various disclosed embodiments may be embodied in program code. The program code may be supplied in a number of ways, for example, on a non-transitory computer readable storage medium, such as a disc or a memory device, e.g. an EEPROM, (for example, that could replace part of memory 103). In some examples, the program code may be provided via data signals (for example, by transmitting the program code from a server). Further, different parts of the program code may be executed by different devices, for example, in a client-server relationship. Persons skilled in the art will appreciate that program code provides a series of instructions executable by a control system, e.g., via one or more processors.

While the invention has been described with respect to the figures, it will be appreciated that many modifications and changes may be made by those skilled in the art without departing from the spirit of the invention. Any variation and derivation from the above description and figures are included in the scope of the present invention as defined by the claims.

What is claimed is:

1. A gaming machine, comprising:
a player interface;
a display system comprising one or more display devices; and
a control system comprising one or more processors and a memory device storing instructions, wherein execution of the instructions by the one or more processors causes, the control system to:
for a play of a base game,
present, based at least in part on an outcome of a random number generator, symbols in a base game display matrix and in a persistent symbol display matrix displayed via the display system;
hold configurable symbols presented in the persistent symbol display matrix at their respective display positions for at least another play of the base game;
trigger, based at least in part on configurable symbols in the base game display matrix, a feature game with an initial quantity of spins;
for each spin of the initial quantity of spins of the feature game:
hold configurable symbols at their respective display positions in the base game display matrix and at their respective display positions in the persistent symbol display matrix;
select, based at least in part on an outcome of the random number generator, replacement symbols for each display position in the base game display matrix and for each display position in the persistent symbol display matrix that is without a held symbol;
activate one or more display positions of the persistent symbol display matrix in response to a persistent symbol display matrix trigger; and
present a feature game award based on a sum of values presented by configurable symbols in the base game display matrix and configurable symbols in activated display positions of the persistent symbol display matrix.

2. The gaming machine of claim 1, wherein execution of the instructions causes the control system to:
activate a zone of the persistent symbol display matrix in response to the replacement symbols presenting a zone activation symbol in the base game display matrix; and
determine the sum of values for the feature game award based on configurable symbols in the active zone of the persistent symbol display matrix, but not configurable symbols in inactive zones of the persistent symbol display matrix.

3. The gaming machine of claim 2, wherein execution of the instructions causes the control system, for each spin of the feature game, to hold the zone activation symbol at its respective display positions in the base game display matrix.

4. The gaming machine of claim 1, wherein execution of the instructions causes the control system to clear configurable symbols from the persistent symbol display matrix after presenting the feature game award.

5. The gaming machine of claim 4, wherein execution of the instructions causes the control system to seed the persistent symbol display matrix with configurable symbols prior to a subsequent play of the base game.

6. The gaming machine of claim 1, wherein execution of the instructions causes the control system to:
activate a first zone of the persistent symbol display matrix in response to the replacement symbols presenting a first zone activation symbol in the base game display matrix;
activate a second zone of the persistent symbol display matrix in response to the replacement symbols presenting a second zone activation symbol in the base game display matrix; and
determine the sum of values for the feature game award based on configurable symbols in active zones of the persistent symbol display matrix, but not on configurable symbols in inactive zones of the persistent symbol display matrix.

7. The gaming machine of claim 6, wherein execution of the instructions causes the control system, for each spin of the feature game, to:
hold the first zone activation symbol at its respective display positions in the base game display matrix; and
hold the second zone activation symbol at its respective display positions in the base game display matrix.

8. The gaming machine of claim 1, wherein execution of the instructions causes the control system to reset a quantity of spins remaining for the feature game in response to the replacement symbols presenting at least one additional configurable symbol

9. The gaming machine of claim 1, wherein execution of the instructions causes the control system to increase the feature game award based on a prize value associated with a row of symbol display positions in an active zone of the persistent symbol display matrix that is filled with configurable symbols.

10. The gaming machine of claim 1, wherein execution of the instructions causes the control system to:
select replacement symbols for a symbol display zone of the base game display matrix from a first symbol set that includes configurable symbols but no zone activation symbols; and
select replacement symbols for a first column and a last column of the base game display matrix from a second symbol set that includes zone activations symbols but no configurable symbols.

11. A method of a gaming machine, comprising, for a play of a base game:
selecting symbols for a base game outcome; a base game display matrix and in a persistent symbol display matrix displayed via a display system;
selecting replacement symbols for each display position in a persistent symbol display matrix that is without a configurable symbol;
presenting, via a display system, the symbols of the base game outcome in a base game display matrix and the replacement symbols in the persistent symbols display matrix while holding configurable symbols already present in the persistent symbol display matrix at their respective display positions; and
after presenting a base game award, retaining configurable symbols at their respective display positions in the persistent symbol display matrix for a subsequent play of the base game.

12. The method of claim 11, comprising:
triggering, based on configurable symbols in the base game display matrix, a feature game with an initial quantity of spins;
for each spin of the feature game:
holding configurable symbols at their respective display positions in the base game display matrix and at their respective display positions in the persistent symbol display matrix; and
selecting replacement symbols for each display position in the base game display matrix and for each display position in the persistent symbol display matrix that is without a held symbol; and
presenting a feature game award based on a sum of values presented by configurable symbols in the base game display matrix and the persistent symbol display matrix.

13. The method of claim 12, comprising:
activating a zone of the persistent symbol display matrix in response to the replacement symbols presenting a zone activation symbol in the base game display matrix; and
determining the sum of values for the feature game award based on configurable symbols in the active zone of the persistent symbol display matrix, but not on configurable symbols in inactive zones of the persistent symbol display matrix.

14. The method of claim 13, comprising holding, for each spin of the feature game, the zone activation symbol at its respective display positions in the base game display matrix.

15. The method of claim 12, comprising clearing configurable symbols from the persistent symbol display matrix after presenting the feature game award.

16. The method of claim 15, comprising seeding the persistent symbol display matrix with configurable symbols prior to the subsequent play of the base game.

17. A non-transitory computer readable storage medium comprising instructions, that in response to being executed, cause a gaming machine to:
for a play of a base game,
present, via a display system based on an outcome of a random number generator of the gaming machine, symbols in a base game display matrix and replacement symbols in a persistent symbol display matrix at display positions of the persistent symbol display matrix without configurable symbols while retaining any configurable symbols in the persistent symbol display matrix at their respective display positions;
trigger, based on the symbols in the base game display matrix, a feature game;
for each spin of the feature game:
select, based on another outcome of the random number generator, replacement symbols for each display position in the base game display matrix and for each display position in the persistent symbol display matrix that is without a configurable symbol;
present the replacement symbols at the display positions in the base game display matrix and the persistent symbol display matrix that are without a configurable symbol while holding configurable symbols already present in the base game display matrix and the persistent symbol display matrix at their respective display positions;
activate a zone of display positions in the persistent symbol display matrix in response to one or more symbols in the base game display matrix; and
present a feature game award based on a sum of values presented by configurable symbols in the base game display matrix and configurable symbols in active zones of the persistent symbol display matrix.

18. The non-transitory computer readable storage medium of claim 17, wherein the instructions, in response to being executed, cause the gaming machine, for each spin of the feature game, to determine the feature game award based on configurable symbols in active zones of the persistent symbol display matrix, but not on configurable symbols in inactive zones of the persistent symbol display matrix.

19. The non-transitory computer readable storage medium of claim 18, wherein the instructions, in response to being executed, cause the gaming machine to activate the zone in the persistent symbol display matrix in response to a zone activation symbol in the base game display matrix.

20. The non-transitory computer readable storage medium of claim 19, wherein the instructions, in response to being executed, cause the gaming machine, for each spin of the feature game, to hold the zone activation symbol at its respective display position in the base game display matrix.
